(19) United States
(12) Patent Application Publication
(10) Pub. No.: US 2005/0171901 A1
(43) Pub. Date: Aug. 4, 2005

(54) Methods and systems for offering a credit card account to a potential home buyer

(75) Inventors: Charles A. Rosenblatt, Richmond, VA (US); Vikas K. Goel, Richmond, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation.

(21) Appl. No.: 10/769,917

(22) Filed: Feb. 3, 2004

(51) Int. Cl. G06F 17/60

(52) U.S. Cl. 705/39

(57) ABSTRACT

Systems and methods are disclosed for offering a credit card account to a potential home buyer. The systems and methods may include determining if a consumer is a potential home buyer and offering a credit card account to the consumer if the consumer is a potential home buyer. Next, the systems and methods may include transferring a balance to the credit card account equal to at least a portion of closing costs associated with the purchased home by the consumer. In addition, the systems and methods may include providing a discount to the consumer on items purchased by the consumer using the credit card account.

### BACKGROUND OF THE INVENTION

I. Field of the Invention

The present invention generally relates to offering a credit card account. More particularly, the present invention relates to methods and systems for offering a credit card account to a potential home buyer.

II. Background Information

Credit card products have become so universally well known and ubiquitous that they have fundamentally changed the manner in which financial transactions and dealings are viewed and conducted in society today. Credit card products are most commonly represented by plastic card-like members that are offered and provided to consumers through credit card issuers (such as banks and other financial institutions). With a credit card, an authorized consumer is capable of purchasing services and/or merchandise without an immediate, direct exchange of cash.

With present credit processing systems, the consumer presents a credit card or credit card number to a merchant. The merchant processes and transmits information, including credit card information and purchase amount, through an established system of electronic clearances and settlements to complete payment. The card issuer is notified of the pending transaction and is given an opportunity to approve it. If approved, a series of clearances and settlements among interchange participants (namely, the merchant, the acquiring bank, the card issuer, and/or the processing institution) results in the card issuer reimbursing the other participants in the process for the cost of the purchase. The card issuer then invoices the consumer for the amount of the purchase and may extend credit such that the consumer can pay the amount of the purchase over time.

In general, the card issuer provides the consumer with a monthly or otherwise periodic statement. The consumer may have the option to either fully pay the outstanding balance, or as a matter of necessity or choice, may defer at least a portion of the balance for later payment with accompanying interest or finance charges for the period during which payment of the outstanding debt is deferred. Following receipt of the statement, the consumer generally mails a check or money order to the card issuer.

Furthermore, consumers purchasing homes traditionally obtain mortgage loans in order to carry out the purchase. Many such consumers, especially first time home buyers, typically need to save money to cover the costs associated with the closing of the mortgage loan. These costs are usually very high. Thus, consumers purchasing a new home often use a substantial amount of their savings to cover the closing costs, leaving little or no money for other expenses after moving into the home.

In view of the foregoing, there is a need for systems and methods for marketing a credit card account to consumers who may potentially purchase a new home. For example, a need exists for offering a credit card account to a consumer in such a way as to help the consumer purchase a home and to subsequently buy items for the purchased home.

### SUMMARY OF THE INVENTION

Consistent with embodiments of the present invention, systems and methods are disclosed for efficiently offering a credit card account to a potential home buyer.

In accordance with one embodiment, methods and systems are disclosed for offering a credit card account to a consumer, comprising determining if the consumer is a potential purchaser of real estate, offering a credit card account to the consumer if the consumer is a potential real estate purchaser, transferring a balance to the credit card account equal to at least a portion of closing costs associated with the purchase of the real estate by the consumer, and providing a predetermined discount to the consumer for items purchased by the consumer using the credit card account.

In accordance with another embodiment, a system for offering a credit card account to a consumer comprises a memory storage for maintaining a database and a processing unit coupled to the memory storage, wherein the processing unit is operative to determine if the consumer is a potential purchaser of real estate, offer a credit card account to the consumer if the consumer is a potential real estate purchaser, transfer a balance to the credit card account equal to at least a portion of closing costs associated with the purchase of the real estate by the consumer, and provide a predetermined discount to the consumer for items purchased by the consumer using the credit card account.

In accordance with yet another embodiment, a computer-readable medium comprising a set of instructions which when executed perform a method for offering a credit card account to a consumer comprising determining if the consumer is a potential purchaser of real estate, offering a credit card account to the consumer if the consumer is a potential real estate purchaser, transferring a balance to the credit card account equal to at least a portion of closing costs associated with the purchase of the real estate by the consumer, and providing a predetermined discount to the consumer for items purchased by the consumer using the credit card account.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary credit card offering system consistent with an embodiment of the present invention;

FIG. 2 is a flow chart of an exemplary method for offering a credit card account to a consumer consistent with an embodiment of the present invention; and

FIG. 3 is a flow chart of an exemplary subroutine used in the exemplary method of FIG. 2 for offering a credit card account to the consumer consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with the invention may determine if a particular consumer is a potential home buyer. As used herein, the term “home” may refer to any type of real estate, including, for example, stand-alone homes, townhouses, condominiums, commercial buildings, undeveloped land, etc. Determining or identifying a potential home buyer may occur when, for example, a consumer contacts a realtor or bank as a first step in purchasing a home (or any type of real estate, as noted above). The same may occur when a consumer contacts a property management company that resells, rents, or leases property. Realtors, banks, and property management companies may provide good leads on potential home buyers because they are often the first contact a potential home buyer makes when desiring to purchase a home. Once the consumer is identified as a potential home buyer, a credit card account may be offered to the consumer through, for example, the realtor, bank, or a management company. Moreover, the credit card account may be offered directly to the consumer through an issuer of the credit card account.

Once the consumer selects and places a contract on the home for purchase, the credit card account may be used to pay all or a portion of closing costs associated with the home's purchase or lease, for example, at the time the card is issued. The card may be issued when the consumer is ready to transfer the closing cost to the credit card. The credit card issuer may provide a low, discounted, or even zero annual percentage rate on any balance transferred to the credit card account for the closing costs.

Further, after closing on the home, many home buyers may need to purchase items associated with the new home. This may be especially true for first time home buyers or for those purchasing homes in need of repair. For example, a first time home buyer may, for the first time, have a yard and thus consequently need a new lawn mower. Similarly, a consumer purchasing an older home that is in need of repair may require other equipment, such as tools, paint supplies, electrical supplies, or plumbing supplies. Consumers may purchase any of the above items using the credit card account used to pay the closing costs. Further, because the consumer used the credit card account to finance the closing costs, and thus already has the credit card account, the consumer may be more likely to use the credit card account to purchase items associated with the new home.

Methods and systems consistent with the invention may provide a discount on items purchased with the offered credit card account that are associated with the new home. This discount may be provided in a number of ways. For example, the credit card account issuer may create a partnership with, for example, a retailer of items typically purchased by home buyers. Such retailers may comprise, but are not limited to national chain hardware or home improvement stores or warehouses. As a result of the partnership, the retailer may provide a discount on items purchased with the credit card account. Likewise, the discount may cause the consumer to make a purchase with the discounted retailer rather than another retailer. Alternately, the credit card issuer itself may apply a discount, or provide points redeemable for value by the consumer, if the consumer uses the credit card account to purchase items with certain retailers. While the retailer and the credit card issuer are often separate entities, they may alternatively be a part of the same entity.

An embodiment consistent with the invention may comprise a system for offering a credit card account to a consumer. The system may comprise a memory storage for maintaining a database and a processing unit coupled to the memory storage wherein the processing unit may be operative to determine if the consumer is a potential home or real estate purchaser. In addition, the processing unit may be operative to offer a credit card account to the consumer if the consumer is a potential real estate purchaser. Furthermore, the processing unit may be operative to transfer a balance to the credit card account equal to at least a portion of the closing costs for the purchased real estate by the consumer. Moreover, the processing unit may operative to provide a discount to the consumer on an item purchased by the consumer using the credit card account.

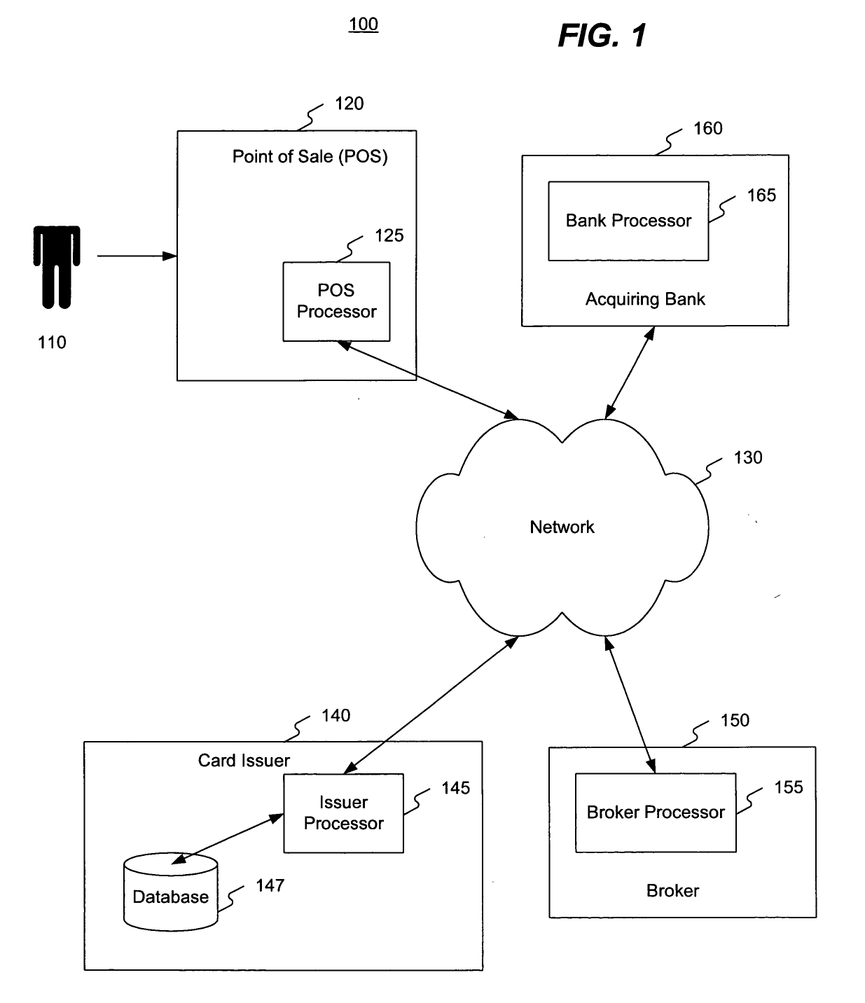

Consistent with an embodiment of the present invention, the aforementioned memory, processing unit, and other components may be implemented in a credit card offering system, such as the exemplary credit card offering system 100 of FIG. 1. Any suitable combination of hardware, software and/or firmware may be used to implement the memory, processing unit, or other components. By way of example, the memory, processing unit, or other components may be implemented with any of a point-of-sale (POS) processor 125, an issuer processor 145, a broker processor 155, or a bank processor 165, in combination with system 100. The aforementioned system and processors are exemplary and other systems and processors may comprise the aforementioned memory, processing unit, or other components, consistent with embodiments of the present invention.

By way of a non-limiting example, FIG. 1 illustrates system 100 in which the features and principles of the present invention may be implemented. As illustrated in the block diagram of FIG. 1, system 100 may include a consumer 110, a point-of sale (POS) location 120, a network 130, a card issuer 140, a broker 150, and an acquiring bank 160. Consumer 110 may be an individual, for example, desiring to purchase a home using broker 150, such as a realtor or property management company. Consumer 110 may also desire to purchase an item (i.e., any product or service) at POS location 120, or desire to open a credit card account through card issuer 140. Further, in addition to being an individual person, consumer 110 may also be an organization or other entity using system 100. Consumer 110 may thus interact with POS location 120 to purchase items (such as those for a recently purchased home), may interact with broker 150 to purchase the home, may interact with bank 160 for a home loan, or may interact with POS location 120 or card issuer 140 to open a credit card account.

POS location 120 may include any merchant connected to network 130, such as those offering items a consumer may purchase for a recently bought home. For example, POS location 120 may include retail stores, service providers, ATM machines, or any other businesses that are equipped to accept credit card transactions. POS location 120 further includes POS processor 125 used to obtain, for example, credit or transaction information from consumer 110 and to transmit that information to other entities connected to network 130. In systems consistent with the present invention, POS 120 may offer a items for sale to consumer 110, as well as a credit card account of issuer 140 to consumer 110. POS location 120 may be connected to card issuer 140 through network 130.

Broker 150 may comprise a realtor or property management company, or any entity associated with the purchase, rental, or lease of real estate. For example, a potential home buyer, when first looking for a home to buy, may contact a realtor or property management company for information regarding homes for sale. Furthermore, a potential home buyer may contact bank 160 (or other financial institutions) to determine the necessary financial arrangements for a home purchase. In either case, the realtor, management company, or bank may comprise a first contact point for determining if consumer 110 is a potential home buyer. Furthermore, the broker 150 or bank 160 may provide the location for closing a mortgage loan and therefore may facilitate in using the offered credit card account to finance the closing costs for the purchased home. Banks, realtors, and property management companies are exemplary, and other enterprises may comprise broker 150 or bank 160 consistent with the invention.

Card issuer 140 may be a bank, financial institution, or any other organization that may provide a credit card to consumer 110. Card issuer 140 may further include an issuer processor 145 and a database 147. Issuer processor 145 may verify and process credit applications and transactions for credit cards issued by card issuer 140. Database 147 may contain account information, such as identifying data and account balance, for each consumer having a credit card issued by card issuer 140. Card issuer 140 may receive requests from POS location 120 and/or broker 150 to verify and initiate credit card transactions including the creation of new credit card accounts.

For example, in a typical purchase-for-credit transaction, consumer 110 presents a credit card issued by card issuer 140 to purchase goods at POS location 120 (such as items for the purchased home), for example. POS processor 125 may gather credit account information and generate a request for a transaction. Processor 125 may then send this request through network 130 to card issuer 140, where the request is received by issuer processor 145. Issuer processor 145 may, in turn, then access database 147 to verify data about the status of the credit account of consumer 110. Based on the accessed information, issuer processor 145 may then approve the requested transaction based on that data. Issuer processor 145 may acknowledge any approval or denial by sending a message through network 130 back to POS processor 125.

Furthermore, system 100 may be used to create a new credit card account for consumer 110. For example, data corresponding to consumer 110 may be collected and stored in database 147. This data may include information about consumer 110 sufficient to perform a consumer credit analysis. The data may be collected from consumer 110 through point-of-sale location 120, and transmitted through network 130 to card issuer 140 where it may be stored in database 147. Moreover, the data may include data from a credit reporting bureau (not shown) or data corresponding to consumer 110 that is not credit related. Issuer processor 145 may perform a consumer credit analysis using at least the data to determine whether to approve a credit card account for consumer.

Acquiring bank 160 may be any financial institution, such as a bank, that may be connected to network 130. Most POS locations 120 or brokers 150 may not interact with card issuers directly to handle many of the operations required to complete a credit card transaction. Thus, POS location 120 or broker 150 may contract with acquiring bank 160 for these tasks. For example, acquiring bank 160 may facilitate the clearance and settlement of receipts and funds between card issuer 140 and POS location 120 or broker 150 by receiving receipts for purchase transactions made using the credit card account, reimbursing POS location 120 or broker 150 for the amount of the transactions, and then seeking reimbursement from card issuer 140. Acquiring bank 160 may receive receipts from POS location 120 for each transaction. Acquiring bank 160 may then provide accounting services with respect to these transactions. For example, acquiring bank 160 may receive receipts indicating purchases made at POS location 120, for which funds should be transferred from card issuer 140 to POS location 120. Acquiring bank 160 may also receive receipts indicating fund transfers made at POS location 120, for which funds should be transferred from POS location 120 to card issuer 140. Acquiring bank 160 may then aggregate all of these transactions and provide a grand total to be transferred from card issuer 140 to POS location 120, or vice versa. Acquiring bank 160 includes bank processor 165 for handling these transactions. Alternatively, POS location 120, and card issuer 140 may complete transactions directly, without the use of acquiring bank 160. Notwithstanding, a transaction causing a balance transfer corresponding to closing costs may be initiated at an attorney's office, a bank, a mortgage company, a realtor's office, or any other location.

Issuer processor 145, POS processor 125, broker processor 155, or bank processor 165 (“the processors”) included in system 100 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 130 may include any data network, such as, for example, an existing secure credit network, a local area network (LAN), a wide area network (WAN), a public telephone switching network, an automated clearing house (ACH) network, or a wide area network, such as the Internet. LAN or WAN networking environments are commonplace in offices, enterprise-wide computer networks, intranets, and the Internet, and are known by those skilled in the art. When a LAN is used as network 130, a network interface located at any of the processors may be used to interconnect any of the processors. When network 130 is implemented in a networking environment, such as the Internet, the processors may typically include an internal or external modem (not shown) or other means for establishing communications over the WAN. Further, in utilizing network 130, data sent over network 130 may be encrypted to insure data security by using known encryption/decryption techniques.

In addition to utilizing a wire line communications system as network 130, a wireless communications system, or a combination of wire line and wireless may be utilized as network 130 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 100 may also transmit credit account data or other types of data by methods and processes other than, or in combination with, network 130. These methods and processes may include, but are not limited to, transferring data via, diskette, CD ROM, facsimile, conventional mail, an interactive voice response system (IVR), or via voice over a publicly switched telephone network.

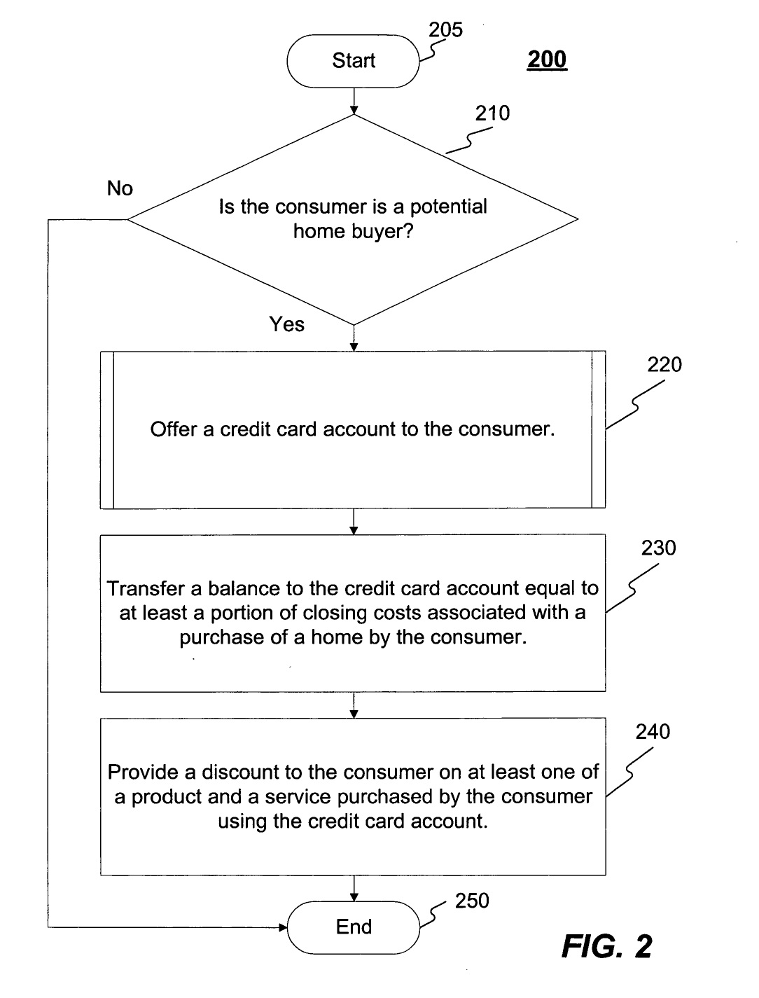

FIG. 2 is a flow chart setting forth the general stages involved in exemplary method for offering a credit card account to a consumer consistent with the invention. Exemplary ways to implement the stages of method 200 will be described in greater detail below. Exemplary method 200 may begin at starting block 205 and proceed to decision block 210 where issuer processor 145 may determine if consumer 110 is a potential home buyer. For example, realtors, banks, and rental property management companies may provide good leads on potential home buyers because they may be the first contact when a potential home buyer manifests a desire to purchase a home. For instance, a potential home buyer may seek out a realtor to discover homes currently for sale or may seek out a bank to determine the requirements for a mortgage loan. Furthermore, a renter may indicate to a rental management company that a current lease will not be renewed because the renter will be purchasing a home. Information concerning these contacts by the consumer may then be sent to account issuer 140 to determine whether consumer 110 is a potential home buyer. Alternatively, issuer 140 may receive from one of these sources data identifying the consumer as a potential home purchaser. The aforementioned enterprises are exemplary and others may provide good leads on potential home buyers. Accordingly, issuer processor may receive (from POS processor 125, broker processor 155, bank processor 165, or other source) information regarding consumer 110's desire to purchase a home. Using this received information, issuer processor 145 may determine if consumer 110 is a potential home buyer.

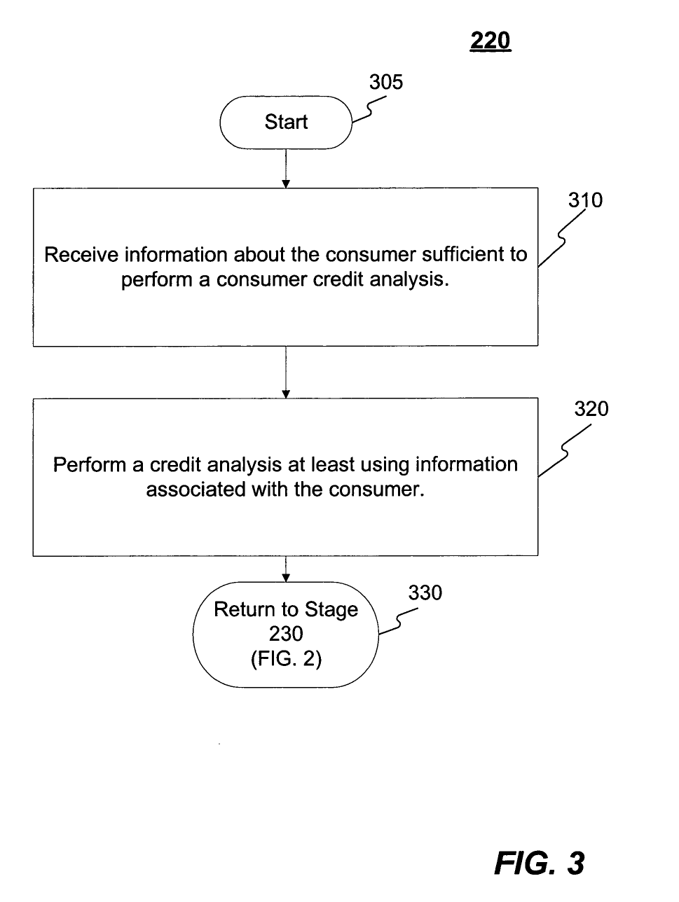

From decision block 210, if issuer processor 145 determines that consumer 110 is a potential home buyer, exemplary method 200 proceeds to exemplary subroutine 220 where issuer processor 145 may offer a credit card account to consumer 110. Exemplary ways to implement the stages of exemplary subroutine 220 will be described in greater detail below with respect to FIG. 3.

Once issuer processor 145 offers the credit card account to consumer 110 in exemplary subroutine 220, exemplary method 200 may then advance to stage 230 where issuer processor 145 may transfer a balance to the credit card account equal to at least a portion of closing costs associated with a purchase of a home by consumer 110. For example, consumer 110 may indicate to a bank or mortgage company representative that the closing costs, or a portion thereof, for the mortgage loan associated with the home purchase should be paid using the credit card account. Consumer 110 may provide a temporary account number to which the bank or mortgage company may transfer the closing costs. As an incentive for consumer 110 to accept the credit card account, card issuer 140 may provide a discounted annual percentage rate on the amount of closing costs transferred to the credit card account, or even provide a zero annual percentage rate for this amount.

After issuer processor 145 transfers the balance of closing costs to the credit card account in stage 230, exemplary method 200 may continue to stage 240 where issuer processor 145 or POS processor 125 may provide a discount to consumer 110 on items purchased by consumer 110 using the credit card account. For example, after a home purchase, many home buyers may need to purchase items associated with the new home as noted above. This may be especially true for first time home buyers or for those purchasing homes needing repair. In purchasing items associated with the new home, a discount on a product or service may be provided to the consumer if the credit card account is used to purchase the particular item.

Consistent with the invention, a discount on such products or services may be provided in a number of ways. For example, the credit card account issuer may create a partnership with, for example, a retailer of items typically purchased by home buyers. Such retailers may comprise, but are not limited to national chain hardware or home improvement store warehouses. The established partnership may cause the retailer to provide a discount on products or services purchased with the credit card account. Alternately, the credit card issuer may apply a discount or provide points redeemable for value if the consumer uses the credit card account to purchase items with certain retailers. Further, as noted above, the retailer and the credit card issuer may comprise the same entity or different entities. Furthermore, the credit card account may also be used in purchase transactions unrelated to the home purchased.

To apply discounts to items purchased by the consumer, account issuer 140 may analyze the purchase transactions made by the consumer using the credit card account. If the account includes purchase transactions made at a retail entity or POS 120 for which a discount applies, issuer 140 may apply the appropriate discount to the transaction amount for that entity or POS 120. Thus, the discount will be reflected in the consumer 110's account balance. As noted above, however, the retail entity or POS 120 may, upon detecting that the consumer 110 is using the above credit card account, determine to apply the discount directly at the point-of-sale location.

From stage 240 where issuer processor 145 or POS processor 125 provides the discount to consumer 110, or if at decision block 210 issuer processor 145 determines that consumer 110 is not a potential home buyer, exemplary method 200 ends at stage 250.

FIG. 3 describes exemplary subroutine 220 from FIG. 2 for offering a credit card account to the consumer. As described above, the credit card account may be offered through, for example, a realtor, a bank, or a point-of-sale location for products or services associated with potential home buyers. Exemplary subroutine 220 begins at starting block 305 and proceeds to stage 310 where issuer processor 145 receives information about consumer 110 sufficient to perform a consumer credit analysis, as well known to those skilled in the art. For example, issuer processor may receive this information about consumer 110 from POS processor 125, broker processor 155, bank processor 165, or other sources.

From stage 310 where issuer processor 145 receives information about consumer 110 sufficient to perform the consumer credit analysis, exemplary subroutine 220 continues to stage 320 where issuer processor 145 performs a credit analysis using the information associated with consumer 110. Once issuer processor 145 performs the credit analysis and offers the credit card account to consumer 110 in stage 320, exemplary subroutine 220, continues to stage 330 and returns to stage 230 of FIG. 2.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method for offering a credit card account to a consumer, the method comprising:
determining if the consumer is a potential purchaser of real estate;
offering a credit card account to the consumer if the consumer is a potential real estate purchaser;
transferring a balance to the credit card account equal to at least a portion of closing costs associated with the purchase of the real estate by the consumer; and
providing a predetermined discount to the consumer for items purchased by the consumer using the credit card account.

2. The method of claim 1, wherein determining if the consumer is a potential real estate purchaser further comprises using at least one of a realtor, a bank, and property management companies to identify a consumer desiring to purchase real estate.

3. The method of claim 1, wherein offering the credit card account to the consumer further comprises offering the credit card account through at least one of a realtor, a bank, and a point-of-sale location.

4. The method of claim 1, wherein the credit card account includes a discounted interest rate on the account balance corresponding to the closing costs transferred to the credit card account, wherein the discounted interest rate is less than the interest rate applied to the balance associated with transactions other than the closing costs.

5. The method of claim 4, wherein the discounted interest rate is zero.

6. The method of claim 1, wherein the discounted purchase items are associated with the purchased real estate.

7. The method of claim 1, wherein the discount is provided through an entity from which the discounted purchase items are purchased.

8. The method of claim 1, wherein the discount is provided by an issuer of the credit card account.

9. The method of claim 1, wherein an issuer of the credit card account and an entity from which the discounted purchase items are purchased, are the same entity.

10. The method of claim 1, wherein providing a predetermined discount to the consumer further comprises:
identifying an entity from which the consumer purchases items using the credit card account;
determining whether items purchased from the identified entity qualify for a discount; and
discounting items purchased from the entity when determining that items purchased from the identified entity qualify for a discount.

11. The method of claim 10, wherein entities from which items purchased qualify for a discount are predetermined by an issuer of the credit card account.

12. The method of claim 1, wherein the credit card account is configured for use by the consumer to make purchase transactions unrelated to the purchased real estate.

13. A system for offering a credit card account to a consumer, the system comprising:
a memory storage for maintaining a database; and
a processing unit coupled to the memory storage, wherein the processing unit is operative to
determine if the consumer is a potential purchaser of real estate;
offer a credit card account to the consumer if the consumer is a potential real estate purchaser;
transfer a balance to the credit card account equal to at least a portion of closing costs associated with the purchase of the real estate by the consumer; and
provide a predetermined discount to the consumer for items purchased by the consumer using the credit card account.

14. The system of claim 13, wherein the processing unit being operative to determine if the consumer is a potential real estate purchaser further comprises the processing unit being operative to use at least one of a realtor, a bank, and property management companies to identify a consumer desiring to purchase real estate.

15. The system of claim 13, wherein the processing unit being operative to offer the credit card account to the consumer further comprises the processing unit being operative to offer the credit card account through at least one of a realtor, a bank, and a point-of-sale location.

16. The system of claim 13, wherein the credit card account includes a discounted interest rate on the account balance corresponding to the closing costs transferred to the credit card account, wherein the discounted interest rate is less than the interest rate applied to the balance associated with transactions other than the closing costs.

17. The system of claim 16, wherein the discounted interest rate is zero.

18. The system of claim 13, wherein the discounted purchase items are associated with the purchased real estate.

19. The system of claim 13, wherein the discount is provided through an entity from which the discounted purchase items are purchased.

20. The system of claim 13, wherein the discount is provided by an issuer of the credit card account.

21. The system of claim 13, wherein an issuer of the credit card account and an entity from which the discounted purchase items are purchased, are the same entity.

22. The system of claim 13, wherein the processing unit being operative to provide a predetermined discount to the consumer further comprises the processing unit being operative to:
identify an entity from which the consumer purchases items using the credit card account;
determine whether items purchased from the identified entity qualify for a discount; and
discount items purchased from the entity when determining that items purchased from the identified entity qualify for a discount.

23. The system of claim 22, wherein entities from which items purchased qualify for a discount are predetermined by an issuer of the credit card account.

24. The system of claim 13, wherein the credit card account is configured for use by the consumer to make purchase transactions unrelated to the purchased real estate.

25. A computer-readable medium comprising a set of instructions which when executed perform a method for offering a credit card account to a consumer, the method comprising:
determining if the consumer is a potential purchaser of real estate;
offering a credit card account to the consumer if the consumer is a potential real estate purchaser;
transferring a balance to the credit card account equal to at least a portion of closing costs associated with the purchase of the real estate by the consumer; and
providing a predetermined discount to the consumer for items purchased by the consumer using the credit card account.

26. The computer-readable medium of claim 25, wherein determining if the consumer is a potential real estate purchaser further comprises using at least one of a realtor, a bank, and property management companies to identify a consumer desiring to purchase real estate.

27. The computer-readable medium of claim 25, wherein offering the credit card account to the consumer further comprises offering the credit card account through at least one of a realtor, a bank, and a point-of-sale location.

28. The computer-readable medium of claim 25, wherein the credit card account includes a discounted interest rate on the account balance corresponding to the closing costs transferred to the credit card account, wherein the discounted interest rate is less than the interest rate applied to the balance associated with transactions other than the closing costs.

29. The computer-readable medium of claim 28, wherein the discounted interest rate is zero.

30. The computer-readable medium of claim 25, wherein the discounted purchase items are associated with the purchased real estate.

31. The computer-readable medium of claim 25, wherein the discount is provided through an entity from which the discounted purchase items are purchased.

32. The computer-readable medium of claim 25, wherein the discount is provided by an issuer of the credit card account.

33. The computer-readable medium of claim 25, wherein an issuer of the credit card account and an entity from which the discounted purchase items are purchased, are the same entity.

34. The computer-readable medium of claim 25, wherein providing a predetermined to the consumer further comprises:
identifying an entity from which the consumer purchases items using the credit card account;
determining whether items purchased from the identified entity qualify for a discount; and
discounting items purchased from the entity when determining that items purchased from the identified entity qualify for a discount.

35. The computer-readable medium of claim 34, wherein entities from which items purchased qualify for a discount are predetermined by an issuer of the credit card account.

36. The computer-readable medium of claim 25, wherein the credit card account is configured for use by the consumer to make purchase transactions unrelated to the purchased real estate.
